(19) United States
(12) Patent Application Publication
(10) Pub. No.: US 2003/0227175 A1
(43) Pub. Date: Dec. 11, 2003

(54) Renewable energy system

(76) Inventors: John Manolis, New York, NY (US); Pete Manolis, New York, NY (US)

Correspondence Address: JOHN MANOLIS, PH.D, P.O. BOX 380, NEW YORK, NY, 10028, US

(21) Appl. No.: 10/350,170

(22) Filed: Jan. 24, 2003

Related U.S. Application Data
(63) Continuation-in-part of application No. 10/164,255, filed on Jun. 7, 2002.

(51) Int. Cl. F03D 9/00; H02P 9/04

(52) U.S. Cl. 290/55

(57) ABSTRACT

A renewable energy system comprising: a cylindrical closed circulated wind tunnel, an electric turbine engine is mounted on the inside wall of said wind tunnel, numerous wind electric generators are mounted on the inside wall of said wind tunnel, also numerous aerodynamic air fins are mounted on the inside wall of said wind tunnel. An electric motor is coaxially mounted on said electrical turbine engine. A solar cells panel is provided to supply the said electric turbine engine with solar electricity. Also an air compressor is provided to supply compressed air into said closed circulated wind tunnel.

### REFERENCE TO RELATED PATENT APPLICATION

The present patent application is a continuation-in part of patent application Ser. No. 10/164,255, filing date Jun. 7, 2002, Group Art Unit 3747, preliminary class 123 and now patent pending.

### BACKGROUND OF THE INVENTION

The present invention relates to a new renewable energy system. This renewable energy system comprises a giant cylindrical closed loop tunnel. A wind tunnel can be an open-or-closed loop system. In an open-loop wind tunnel, the intake and exhaust ends of the tunnel are not connected which possess numerous drawbacks and disadvantages. The modern wind tunnels are of closed-loop tunnel systems. In a closed-loop tunnel the fast-moving air coming out of the tunnel can be re-circulated into the intake end of the tunnel to help boost total air speed. This is how a closed-loop tunnel operates. The present invention describes a cylindrical closed-loop tunnel which has a circular or ellipsoidal configuration to minimize turbulence and power loss and increase the velocity of the air flow in the tunnel. A giant electrical turbine with air intake port and air exhaust port is mounted on the inside wall of the closed-re-circulated wind tunnel. Numerous wind electric generators are circularly or ellipsoidal mounted on the inside wall of the tunnel, the blades of the wind electric generators face the air outlet port of the electric turbine. Also numerous aerodynamic air fins are circularly or ellipsoidal mounted on the inside wall of the tunnel to direct the exhausted wind from the electric turbine to flow directly on the blades of the wind electric generators. An air compressor mounted outside the tunnel has an air pipe with nozzle connected to the tunnel to pump compressed air into the tunnel to increase the density and the velocity of the wind flowing circularly or ellipsoidally clockwise inside the wind tunnel, and also to increase the thrust of the electric turbine.

The enormous front fan of the turbine is about 10.25 feet diameter and uses wide chord fan blades to draw in more than 1,000 pounds of air per second, which could produce a 115,000 pound-thrust. Load on a fan blade at full power is almost 100 tons; the equivalent of hanging a main-line diesel locomotive on each blade. There are ninety-two turbine blades in the engine. Each one generates about 750 horsepower. The exhausted air from the engine becomes compressed wind, circulates therethrough in the closed-loop tunnel with high velocity. As it flows through it rotates the blades of numerous chain wind electric generators inside the wind tunnel. The blades of the wind electric generators are extremely strong and have the ability to bend on impact, a vital asset which dramatically reduces the potential damage from the strong win which could blow with 115,000 pound-thrust (519 kN) the equivalent of 57.5 tons of power.

This renewable wind energy breakthrough relates action and chain reaction. The action is a stream of compressed air exhausted from the turbine, and it becomes a powerful wind which flows in circle through the closed-loop tunnel. The chain reaction is when these powerful winds rotate the blades of a chain of numerous wind electric generators mounted on the inside wall of the tunnel.

An electric motor is coaxially mounted on the engine, when the turbine starts to rotate the enormous front fan air is drawn into the turbine through the engine's intake port. The air flows into a compressor. The compressor is a core surrounded by fanlike blades. The compressor's core is big at the front of the engine and small at the back of the engine. The air flows through sets of fan-like blades that compress it. Air heats up as it is compressed. The compressed hot air shoot past the turbine blades. The movement of the compressed hot air makes the turbine rotate. As the turbine rotates, it rotates the compressor and the enormous front fan to draw in and compress about 1,000 pounds air per second at full power and the action endlessly continues.

A solar cells panel is mounted near the tunnel and connected with electrical wires to a battery to store solar electricity. The battery is connected with electrical wires to an electric motor coaxially mounted on the turbine. The electric motor operates the turbine.

### SUMMARY OF THE INVENTION

It is an object of the present invention to provide a new renewable energy system.

It is another object of the present invention to provide a closed-re-circulated wind tunnel with a circular configuration.

It is another object of the present invention to provide a closed-re-circulated wind tunnel with a ellipsoidal configuration.

Still it is an object of the present invention to provide a closed-re-circulated wind tunnel with numerous aerodynamic air fins circularly mounted on the inside wall of the wind tunnel.

Still it is another object of the present invention to provide a closed-re-circulated wind tunnel with an air pipeline with nozzle connected to the wind tunnel and to an air compressor.

Still it is a further object of the present invention to provide a closed-re-circulated wind tunnel with a chain of numerous wind electric generators circularly mounted on the inside wall of the tunnel.

Yet it is an object of the present invention to provide a closed-re-circulated wind tunnel with a chain of wind electric generators ellipsoidal mounted on the inside wall of the tunnel.

Yet it is another object of the present invention to provide a closed re-circulated wind tunnel with an electric turbine which generates wake-vortex in the tunnel.

Yet it is a further object of the present invention to provide a wind electric generator with flying wheels mounted on the blades of said wind electric generator, which create centrifugal force and increase the acceleration and rotational speed of the blades of the wind electric generators.

### BRIEF DESCRIPTION OF THE DRAWINGS

FIG. 1 is a sectional top view of a cylindrical closed-re-circulated wind tunnel with ellipsoidal configuration, an electric turbine engine is mounted on the inside wall of the tunnel, a chain of numerous wind electric generators are ellipsoidal mounted on the inside wall of the wind tunnel. Also a chain of numerous aerodynamic air fins are ellipsoidal mounted on the inside wall of said tunnel.

FIG. 2 is a front view of a solar cells panel with electrical wires connected to a battery.

FIG. 3 is a battery connected to the solar cells panel with electrical wires and also connected to the electric motor of the turbine engine with electrical wires.

FIG. 4 is a front view of a wind electric generator comprising: a circular flying wheel mounted on the blades of said wind electric generator to create centrifugal force and increase the acceleration and the rotational speed of the blades of said wind electric generators.

FIG. 5 is a cross sectional view of a giant electric Jet-engine which comprises: an electric motor coaxially mounted on the engine, numerous large front fans, compressor blades and turbine blades, also a large intake port and an exhaust port. The large front fans pull air into the engine, part of said air is forced into a compressor chamber by the compressor's blades. The compressed air shoots past the turbine blades and turns said turbine.

### DETAILED DESCRIPTION OF PREFERRED EMBODIMENT

Referring now more particularly to the accompanying drawings, wherein like reference numerals designate similar parts throughout the various views. FIG. 1 illustrates an exemplary ellipsoidal close circulated wind tunnel 1 which has no intake port or exhaust port, the air in the wind tunnel 1 is compressed and re-circulated clockwise with very high velocity.

A giant electric jet-engine 2 is mounted inside the wind tunnel 1, the engine 2 has intake port 3 and exhaust port 4, an electric motor 5 is coaxially mounted on the engine 2. Numerous wind electric generators 6, 7, 8, 9, 10, 11, 12, 13, 14, 15, 16, 17, 18, 19, 20, 21, 22, 23, 24, 25, are ellipsoidal mounted on the inside wall of the closed wind tunnel 1, said wind electric generators 6 through 25 are stationary facing the exhaust port 4 of the engine 2. Also numerous aerodynamic air fins 26, 27, 28, 29, 30, 31, 32, 33, 34, 35, 36, 37, 38, 39, 40, 41, 42, 43, 44, 45, 46, 47, 48, 49 and 50 are ellipsoidal mounted on the inside wall of wind tunnel 1, to direct the wake-vortex of the wind directly on the blades of the wind electric generators 6 through 25.

An automatic air compressor 71 with nozzle 72 is mounted on the tunnel 1 to maintain air density and pressure in the tunnel 1. The area, between the wind electric generator 25 and the intake port 3 of the engine 2, is the diffuser area. The diffuser causes the compressed wind in the tunnel to blow with high velocity, as the compressed air rushes to occupy the diffuser's area between wind, electric generator 25 and intake port 3 of engine 2. The closed wind tunnel 1 of the present invention operates with compressed wind and heavy air. At every point in the closed wind tunnel 1 except the diffuser, density X velocity X cross-sectional area=a constant

r×V×A=constant.

The highest velocities are obtained in the hypervelocity tunnel of the Ames Research Center, which created air velocities of up to 48,000 km/h (about 30,000 mph) only for short periods of time.

FIG. 2 is a front view of a solar cells panel 51, which has solar cells 52 to generate solar electricity. The solar cells panel 51 is connected to a battery 54 with wires 53. Solar electricity is stored in the battery 54.

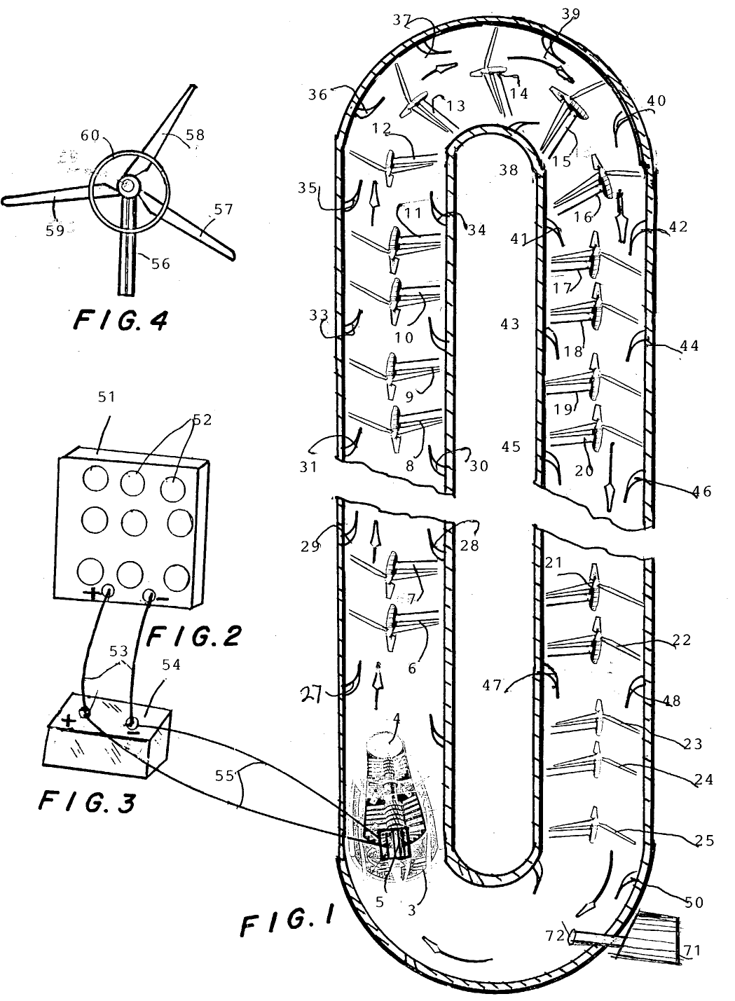

FIG. 3 is a front and top view of a battery 54 which stores solar electricity generated by the solar cells panel 51. The battery 54 is connected with wires 55 to the electric motor 5 coaxially mounted on the engine 2. The motor 5 utilizes electricity from the battery 54 to operate the engine 2.

FIG. 4 is a front view of a horizontal-axis wind turbine 56 which comprises blades 57, 58 and 59. An aerodynamic circular flying wheel 60 is mounted on said blades 57, 58 and 59 of wind turbine 56, said circular flying wheel 60 generates centrifugal forces. Aerodynamic and centrifugal forces act together to increase the acceleration and the rotational speed of said blades 57, 58 and 59.

The blades of said wind turbines are extremely strong. They have a tensile strength exceeding 100,000 psi, twice as strong as steel. Also, they have the ability to bend on impact, a vital asset which dramatically reduces the potential damage from the strong wind which could flow with high velocity of about 500 mph, and about 120,000 pound-thrust (510 kN) the equivalent of 57.5 tons of power.

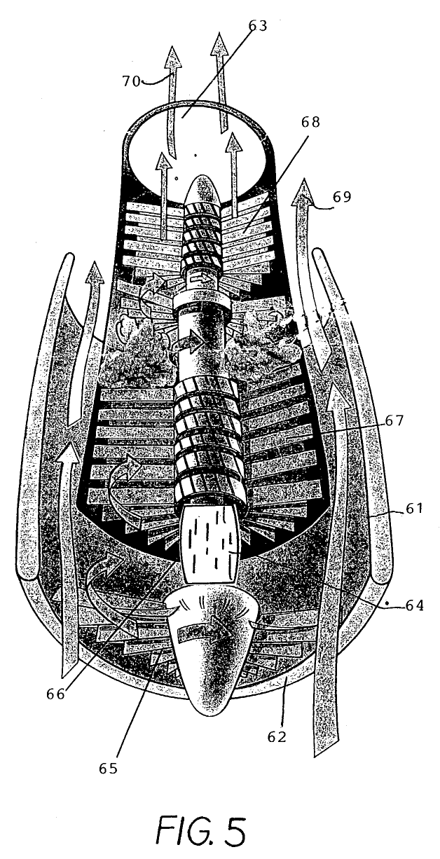

FIG. 5 is a cross-sectional view of an electric jet-like engine 61 comprising: intake port 62, exhaust port 63, an electric motor 64 coaxially mounted on said engine 61. the enormous size of the front fan 65 of said engine 61 is about 10.25 foot diameter and uses wide chord fan blades to draw in more than 1,000 pounds of air per second, which could produce about 120,000 pound-thrust (510 kN) the equivalent of 57.5 tons of power. Load on a fan blade 65 at full power is about 100 tons: the equivalent of hanging a main line diesel locomotive on each blade 65. There are ninety-two blades 65 of the engine 61. Each blade 65 generates about 750 horsepower. The blades 65 force air to enter the compressor 66. The compressor 66 is a core surrounded by fanlike blades 67. The core of compressor 66 is big at the front of the engine 61 and small at the back of said engine 61. The fanlike blades 67 compress the air. As the air is compressed it heats up. The hot air shoots past the turbine blades 68. The movement of hot air makes the turbine rotate. As the turbine rotates it rotates the blades 67 of the compressor 66 and the front fans 65 to take in more air and compress it and force it to generate a wake-vortex 69 and 70 which flows out of the exhaust port 63 and therethrough into the entire length of the wind tunnel 1 with high density and velocity. The high density and high velocity rotate the blades of numerous wind electric generators to generate electric energy.

Since the construction and the advantages of the present invention may be readily understood from the forgoing embodiments, further explanation is believed to be unnecessary. However, since numerous modifications will readily occur to those skilled in the art from the forgoing specification and accompanying drawings, it is not intended that the invention be limited to any particular embodiment disclosed herein, but variations, modifications and equivalents may be made therefrom which fall within the scope of appended claims.

What is claimed is:

1. A renewable energy system comprising:
(i) a cylindrical wind tunnel;
(ii) an electric turbine engine;
(iii) numerous wind electric generators;
(iv) numerous aerodynamic air fins;
(v) a circular flying wheel;
(vi) an electric motor;
(vii) an air compressor;
(viii) a solar cells panel; and
ix) batteries.

2. A renewable energy system according to claim 1, wherein said wind tunnel is a cylindrical closed circulated wind tunnel which has an ellipsoidal configuration.

3. A renewable energy system according to claim 1, wherein said electric turbine engine is mounted on the inside wall of said closed circulated wind tunnel.

4. A renewable energy system according to claim 1, wherein said electric turbine has an air intake port and an air exhaust port.

5. A renewable energy system according to claim 1, wherein said electric motor is coaxially mounted on said electric engine.

6. A renewable energy system according to claim 1, wherein said numerous wind electric generators are mounted on the inside wall of said closed circulated wind tunnel.

7. A renewable energy system according to claim 1, wherein said numerous aerodynamic air fins are mounted on the inside wall of said closed circulated wind tunnel.

8. A renewable energy system according to claim 1, wherein said circular flying wheel is mounted on the blades of said wind electric generators.

9. A renewable energy system according to claim 1, wherein said air compressor is mounted on said closed circulated wind tunnel.

10. A renewable energy system according to claim 1, wherein said air compressor has an air pipe with nozzle to introduce compressed air into said closed circulated wind tunnel.

11. A renewable energy system according to claim 1, wherein said solar cells panel generates solar electricity and it is connected to a battery with electrical wires.

12. A renewable energy system according to claim 1, wherein said battery stores solar electricity from said solar cells panel and it is connected with said electric motor coaxially mounted on said electric turbine engine.

13. A renewable energy system according to claim 1, wherein said close circulated wind tunnel is made of steel.

14. A renewable energy system according to claim 1, wherein said closed circulated wind tunnel is made of cement.

15. A renewable energy system according to claim 1, wherein said closed circulated wind tunnel is made of aluminum.

16. A renewable energy system according to claim 1, wherein said closed circulated wind tunnel is made of plastic.

17. A renewable energy system according to claim 1, wherein said closed circulated wind tunnel is constructed above ground.

18. A renewable energy system according to claim 1, wherein said closed circulated wind tunnel is constructed underground.
